(19) United States
(12) Patent Application Publication
(10) Pub. No.: US 2020/0065537 A1
(43) Pub. Date: Feb. 27, 2020

(54) AUTOMATIC FORM DATA READING

(71) Applicant: Zebra Technologies Corporation, Lincolnshire, IL (US)

(72) Inventors: Duanfeng He, South Setauket, NY (US); Kenneth S. Bhella, Stony Brook, NY (US); Lindsay M. Fahmi, Shelton, CT (US); David S. Koch, East Islip, NY (US); Dongqing Chen, East Setauket, NY (US)

(21) Appl. No.: 16/109,359

(22) Filed: Aug. 22, 2018

(51) Int. Cl. G06K 7/14; G06K 9/32; G06K 9/78; G06K 9/20; G06K 7/10

(52) U.S. Cl. CPC G06K 7/1413; G06K 9/325; G06K 9/78; G06T 7/70; G06K 7/10722; G06K 2209/01; G06K 2209/27; G06K 9/2072

(57) ABSTRACT

Embodiments of the present invention generally relate to the field of inventory management. In an embodiment, the present application is a method of reading barcodes. The method includes capturing, by an imaging assembly, an image of a target, the target including: (i) a symbol encoding a payload data, and (ii) a set of one or more alphanumeric characters containing a payload descriptor associated with the symbol; decoding, by a first processor, the symbol to extract the payload data; performing, by a second processor, an optical character recognition analysis on the set of one or more alphanumeric characters to identify the payload descriptor associated with the symbol; associating the payload data with the payload descriptor, resulting in an associated pair; and forwarding the associated pair to a third processor for further processing of the payload data based on the payload descriptor.

### BACKGROUND OF THE INVENTION

Containers in retail, shipping, and inventory environments are often affixed with barcodes that identify the item and/or describe various characteristics of the product, such as, e.g., the manufacturer of the product, the origin of the product, the intended destination of the product, a serial number associated with the product, etc. A single product is often affixed with a plurality of barcodes to convey all of this information. Near each barcode, there is typically a word or acronym indicating what that barcode conveys (e.g., “Serial No.” near a barcode that conveys the item's serial number).

Between various products, manufacturers, distributors, and retailers, there is no uniform order or orientation in which these various barcodes are displayed when they are affixed to an item. Referring now to the drawings, FIGS. 1A-1C illustrate exemplary barcode configurations. For example, each of the barcode configurations shown in FIGS. 1A-1C are used on packaging for mobile phones from various manufacturers and distributors.

Each barcode configuration includes a different set of barcodes. For example, FIG. 1A includes an AT&T-specific barcode, which FIGS. 1B and 1C do not include. As another example, FIG. 1B includes a “Part. No.” barcode, which FIGS. 1A and 1C do not include. As still another example, FIG. 1C includes a “PRL” barcode, which FIGS. 1A and 1B do not include. Furthermore, even the barcodes in common between the barcode configurations are displayed in a different order in each case. Moreover, each barcode configuration is arranged differently. For example, FIG. 1A includes both vertically- and horizontally-oriented barcodes, while FIGS. 1B and 1C only include horizontally-oriented barcodes. As another example, FIG. 1B includes two columns of horizontally-oriented barcodes, while FIG. 1C includes only one column of horizontally-oriented barcodes.

This wide variation in barcode configurations has in many cases impeded previous attempts to automate the barcode-scanning process. Currently, human workers must manually locate and identify the word or acronym describing each barcode affixed to an item, and separately scan and enter each barcode based on its description. For example, a human worker may be prompted to scan an SKU barcode. The human worker must then locate the SKU barcode where it is affixed to the product and point a scanner at that barcode to scan it. Then, the worker is prompted to scan another barcode and the process repeats. This process is extremely time consuming, as well as prone to error, when there are many products to be scanned. Additionally, for a human worker to be able to perform the tasks as outlined above, the worker must be trained properly to recognize the different barcodes and their functionalities. Accordingly, there exists a need for improved, automated means to read barcodes.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A-1C illustrate several exemplary barcode configurations, in accordance with an example.

FIG. 2 illustrates an exemplary block diagram schematic of a system for reading barcodes, in accordance with an embodiment of the present invention.

FIG. 3 illustrates a target including (i) a symbol encoding payload data and (ii) alphanumeric characters containing a payload descriptor associated with the symbol, in accordance with an example.

FIG. 4 illustrates a flowchart representative of a method of reading barcodes, in accordance with an embodiment of the present invention.

FIG. 5 illustrates a flowchart representative of a method of reading barcodes, in accordance with an embodiment of the present invention.

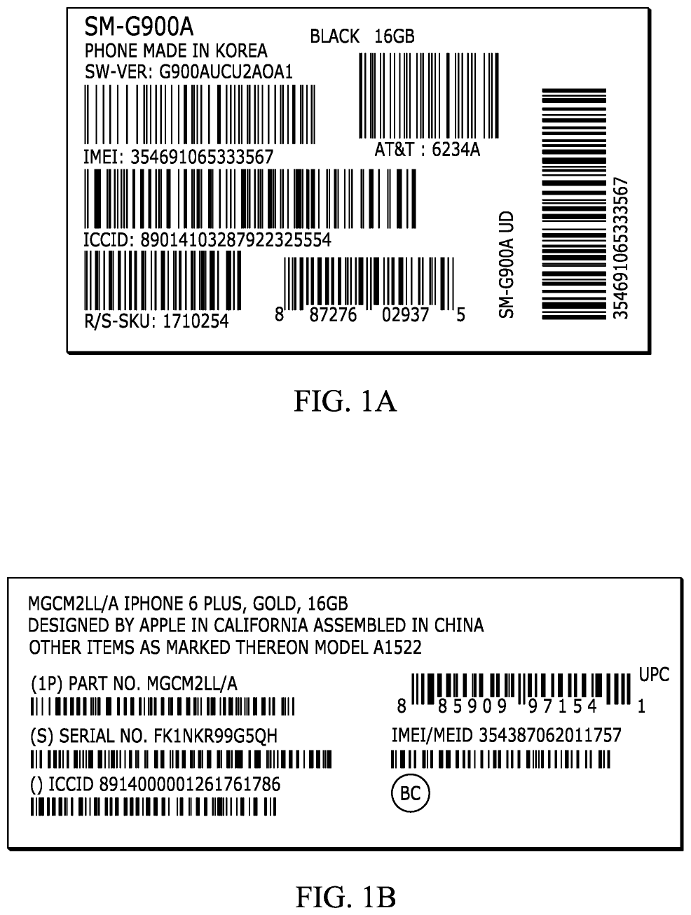

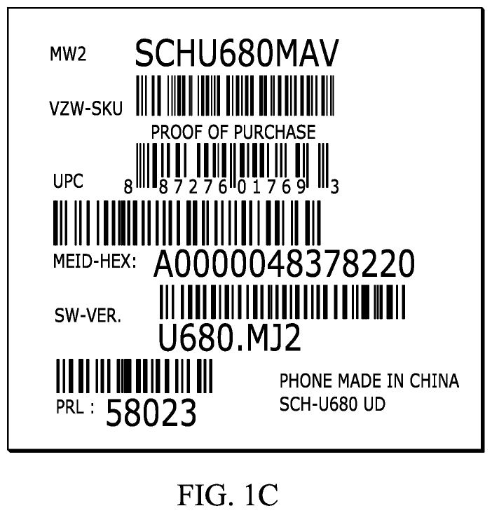

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In an embodiment, the present invention is a method for reading barcodes. The method includes capturing, by an imaging assembly, an image of a target, the target including: (i) a symbol encoding a payload data, and (ii) a set of one or more alphanumeric characters containing a payload descriptor associated with the symbol; decoding, by a first processor, the symbol to extract the payload data; performing, by a second processor, an optical character recognition analysis on the set of one or more alphanumeric characters to identify the payload descriptor associated with the symbol; associating the payload data with the payload descriptor, resulting in an associated pair; and forwarding the associated pair to a third processor for further processing of the payload data based on the payload descriptor.

In another embodiment, the present invention is a method for reading barcodes. The method includes capturing, by an imaging assembly, an image of a target, the target including: (i) a first symbol encoding a first payload data, (ii) a second symbol encoding a second payload data, (iii) a first set of one or more alphanumeric characters containing a first payload descriptor associated with the first symbol, and (iv) a second set of one or more alphanumeric characters containing a second payload descriptor associated with the second symbol; decoding, by a first processor, the first symbol to extract the first payload data; decoding, by the first processor, the second symbol to extract the second payload data; performing, by a second processor, an optical character recognition analysis on the first set of one or more alphanumeric characters to identify the first payload descriptor associated with the first symbol; performing, by the second processor, an optical character recognition analysis on the second set of one or more alphanumeric characters to identify the second payload descriptor associated with the second symbol; associating the first payload data with the first payload descriptor, resulting in a first associated pair; associating the second payload data with the second payload descriptor, resulting in a second associated pair; forwarding the first associated pair to a third processor for further processing of the first payload data based on the first payload descriptor; and forwarding the second associated pair to a fourth processor for further processing of the second payload data based on the second payload descriptor.

In still another embodiment, the present invention is a system for reading barcodes. The system includes an imaging assembly configured to capture an image of a target, the target including: (i) a symbol encoding a payload data, and (ii) a set of one or more alphanumeric characters containing a payload descriptor associated with the symbol; a memory configured to store computer executable instructions; and at least one processor configured to interface with the image capture device and the memory, and configured to execute the computer executable instructions. The computer executable instructions cause the at least one processor to: decode the symbol to extract the payload data; perform an optical character recognition analysis on the set of one or more alphanumeric characters to identify the payload descriptor associated with the symbol; associate the payload data with the payload descriptor, resulting in an associated pair; and forward the associated pair for further processing of the payload data based on the payload descriptor.

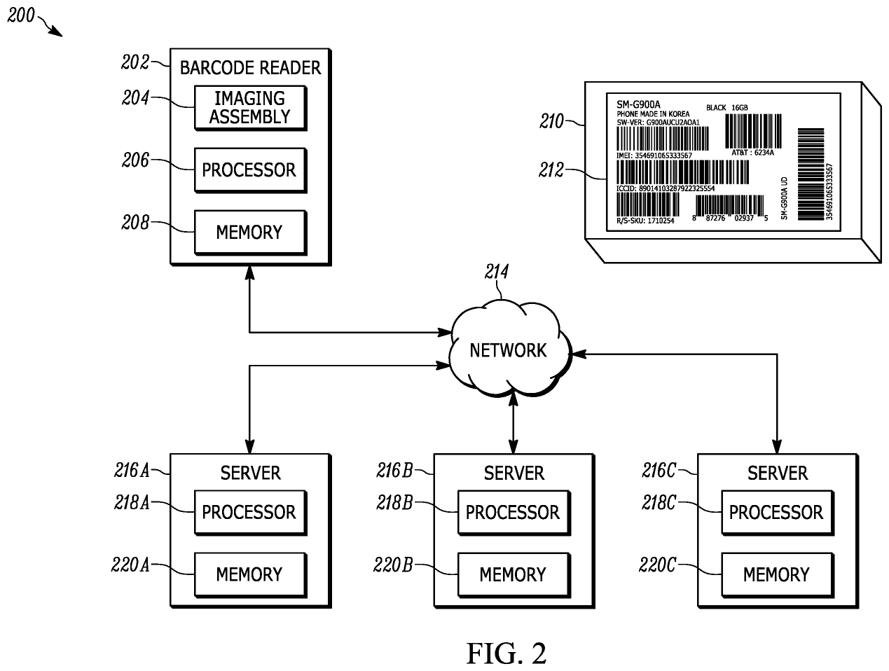

Referring now to the drawings, an exemplary block diagram schematic of a system for reading barcodes is illustrated in FIG. 2, in accordance with an embodiment of the present invention. As shown in FIG. 2, a barcode reader 202 may include an imaging assembly 204 (e.g., a camera), one or more processors 206, and a memory 208. The imaging assembly 204 may be configured to capture an image of a target 212, which may be, e.g., a sticker affixed to a physical object 210, such as a package, container, etc. In some instances, the imaging assembly 204 may be located separately from the processor 206 and the memory 208. In such instances, images captured by the imaging assembly 204 may be transmitted to the memory 208 (e.g., via the network 214).

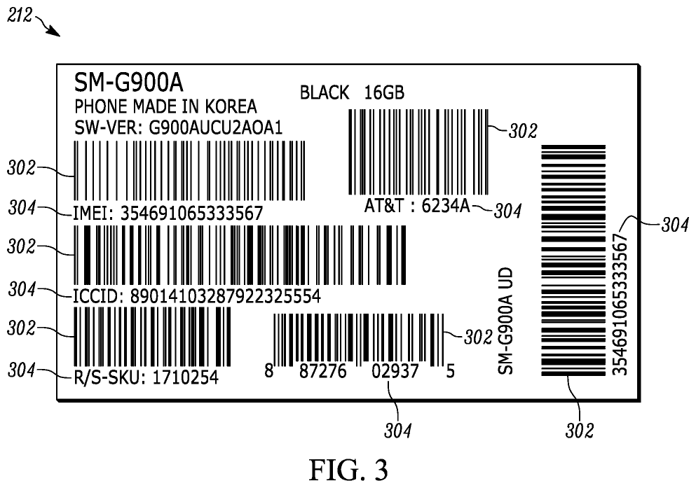

FIG. 3 illustrates a more detailed view of an exemplary target 212, in accordance with an example. As shown in FIG. 3, the target 212 includes one or more symbols 302 (e.g., barcodes) encoding payload data (e.g., a series of numbers). Additionally, the target 212 includes one or more sets of alphanumeric characters 304, each containing a payload descriptor associated with each symbol 302. These alphanumeric characters may include, e.g., numbers, upper and/or lower case letters, punctuation marks, symbols, etc. For example, the payload descriptor may be a word or acronym describing what is encoded in each barcode (e.g., “IMEI.” describes that the barcode encodes an International Mobile Equipment Identity number). In some instances, the set of alphanumeric characters 304 may further include an alphanumeric string corresponding to the payload data encoded in the symbol 302 (e.g., the string of numbers “354691065333567” next to IMEI corresponds to the payload data described by the payload descriptor “IMEI”). Each set of alphanumeric characters 304 may be located in close proximity to an associated symbol 302 in the target 212. For example, a set of alphanumeric characters 304 may be oriented and/or located below its associated symbol 302, as shown in FIG. 3. In other examples, however, the set of alphanumeric characters 304 may be oriented and/or located above the symbol 302, or otherwise close to the symbol 302.

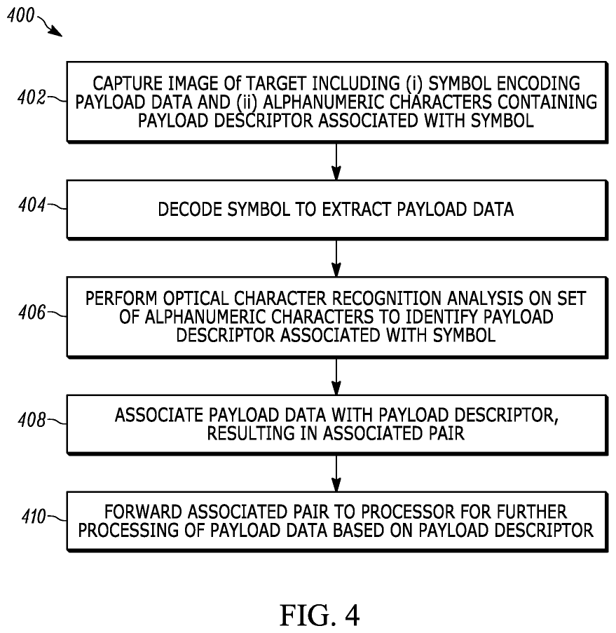

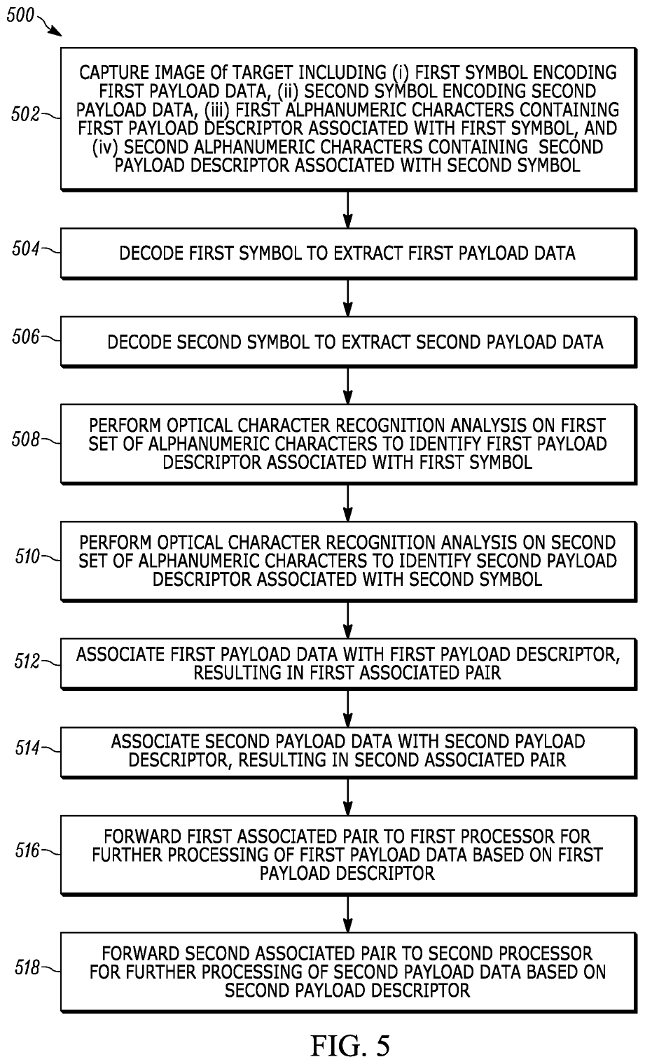

Turning back to FIG. 2, the barcode reader 202 may further include a number of various software applications (not shown) stored in the memory 208. Each of the various software applications may be executed on the same processor 206 or on different processors, in various embodiments. Generally speaking, one or more of the applications may perform at least a portion of any of the method 400 shown in FIG. 4 and/or the method 500 shown in FIG. 5. For example, the applications may perform one or more functions related to, inter alia, performing an optical character recognition analysis on one or more sets of alphanumeric characters 304 in order to identify payload descriptors (e.g., to automatically identify words or acronyms, or portions of words or acronyms, describing a given barcode) and/or an alphanumeric string corresponding to the payload data encoded in the symbol 302; decoding one or more symbols 302 to extract payload data encoded in the symbols 302; associating the payload data with the respective payload descriptor, resulting in an associated pair; forwarding the associated pair to another processor for further processing of the payload data based on the payload descriptor, etc. In some instances, two or more of the foregoing applications may be combined as an integral application. Moreover, additional or alternative applications may be included in various embodiments.

The system may further include one or more servers 216A, 216B, 216B, configured to communicate with the barcode scanner 202, e.g., via a network 214. Although three servers 216A, 216B, 216C are shown in FIG. 2, it will be appreciated that any number of servers may be included in the system in various embodiments. Each server 216A, 216B, 216C may include a processor 218A, 218B, 218C and a memory 220A, 220B, 220C. In some instances, a first associated pair may be forwarded to a first processor 218A for further processing based on a first payload descriptor, while a second associated pair may be forwarded to a second processor 218B for further processing based on a second payload descriptor, a third associated pair may be forwarded to a third processor 218C for further processing based on a third payload descriptor, etc. Of course, in some instances, some associated pairs may be forwarded to the same processor for further processing based on their respective payload descriptors. Moreover, in some instances, an associated pair may be processed by the processor 206. Furthermore, in some embodiments, one or more of the processors 218A, 218B, 218C may be configured to perform any suitable portion of the processing functions remotely that have been described as being performed by the processor 206, and vice versa.

Turning now to FIG. 4, shown therein is a flowchart representative of a method 400 of reading barcodes, in accordance with an embodiment of the present invention. The method 400 can be implemented as a set of instructions stored on a computer-readable memory and executable on one or more processors.

In step 402, the method includes the operation of capturing (e.g., by an imaging assembly) an image of a target. In some examples, the target may be affixed to a physical object, such as a package, container, etc. The target may include (i) a symbol encoding payload data and (ii) a set of one or more alphanumeric characters containing a payload descriptor associated with the symbol. Generally speaking, the symbol may be, e.g., a 1D barcode, a 2D barcode, such as a QR code, or any other symbol suitable for encoding payload data. The payload data encoded by the symbol may be a string of numbers. The alphanumeric characters may be located near the symbol, e.g., immediately above or below the symbol, or adjacent to the symbol. Furthermore, the payload descriptor may be a word or acronym describing what is encoded by the symbol (e.g., IMEI, SKU, Serial. No., UPC, etc.). In some instances, the alphanumeric characters may further include an alphanumeric string corresponding to the payload data.

In step 404, the method includes the operation of decoding the symbol to extract the payload data. For example, the extracted payload data may be data indicating a string of numbers and/or characters encoded by a barcode. In step 406, the method includes the operation of performing an optical character recognition analysis on the set of one or more alphanumeric characters to identify the payload descriptor associated with the symbol. In some instances, an optical character recognition analysis may also be performed on the alphanumeric string corresponding to the payload data to identify a string of numbers or characters. In some examples, the optical character recognition analysis may be performed on only a certain region of the image of the target where the set of alphanumeric characters is likely to be located, e.g., a region within a certain proximity of the symbol from which the payload data is extracted. Of course, in other examples, the optical character recognition analysis may be performed over the entire image of the target.

In some instances, there may be errors in the optical character recognition analysis In such instances, the payload descriptor (with errors) from the optical character recognition analysis may be identified by matching the payload descriptor (with errors) to the closest payload descriptor from a known set of possible payload descriptors (e.g., using fuzzy logic). For example, if the payload descriptor (with errors) generated by the optical character recognition analysis is “IMEF”, it may be matched to the known payload descriptor “IMEI” (rather than, e.g., another, less similar, known payload descriptor “SKU”) using fuzzy logic, or any other known method for comparison of analyzed characters to known payload descriptors. Accordingly, the payload descriptor may be identified as an “IMEI” payload descriptor.

Similarly, the alphanumeric string (with errors) from the optical character recognition analysis may be identified by matching the alphanumeric string (with errors) to the extracted payload data, (e.g., using fuzzy logic). While both decoding barcodes and OCR may incur errors, the error rate associated with OCR is typically much higher. Accordingly, when there are differences between the alphanumeric string corresponding to the payload data and the payload data extracted from the symbol, the payload data extracted from the symbol typically will be used to identify the alphanumeric string (rather than vice versa). For example, if the alphanumeric string (with errors) generated by the optical character recognition analysis is “1710258,” it may be matched to the extracted payload data from the symbol, “1710254,” using a fuzzy logic comparison, or any other known method for comparison. Accordingly, the alphanumeric string may be identified as a “1710254” alphanumeric string.

In step 408, the method includes the operation of associating the payload data with the payload descriptor, resulting in an associated pair. In some examples, the payload data may be associated with the payload descriptor based on the position of the alphanumeric characters containing the payload descriptor with respect to the symbol encoding the payload data, e.g., in the captured image of the target. For example, the set of alphanumeric characters may be positioned immediately above or immediately below the symbol in some instances. Additionally or alternatively, the payload data may be associated with the payload descriptor based on the proximity of the alphanumeric characters to the symbol (e.g., based on whether the alphanumeric characters are within a certain threshold distance of the symbol). For example, in embodiments where the optical character recognition analysis is performed only within a certain region of the image of the target, the set of alphanumeric characters may be located within that region of the image (and may be the only set of alphanumeric characters positioned within that region of the image).

In some instances, the payload data may be associated with the payload descriptor based on the identified alphanumeric string corresponding to the second payload data. For example, the alphanumeric characters “R/S-SKU 1710254” are shown in FIG. 3. In this example, R/S-SKU is the payload descriptor, and 1710254 is the alphanumeric string. If one of the barcodes encodes the alphanumeric string “1710254”, matching the alphanumeric string contained in the set of alphanumeric characters, then the payload descriptor “R/S-SKU” contained in the same set of alphanumeric characters may be associated with the payload data.

In step 410, the method includes the operation of forwarding the associated pair to a processor for further processing of the payload data based on the payload descriptor. In some instances, the further processing of the payload data may include inputting payload data into fields for specific payload descriptors, e.g., in an inventory application. Additionally or alternatively, the further processing of the payload data based on the payload descriptor may include changing the location of a physical object (e.g., a package, a product, a container, etc.) to which the target is affixed. For example, payload data including a code for a destination, associated with a payload descriptor indicating “destination” may indicate that a package to which the target is affixed should be put in a truck heading to that destination. As another example, payload data indicating a code for a type of product, associated with a payload descriptor indicating “product type” may indicate that a package to which the target is affixed should be placed in a certain area of a retail store. Accordingly, an incorrect association between payload data and payload descriptor could lead to a package to which the target is affixed being placed in an incorrect location.

Referring now to FIG. 5, shown therein is a flowchart representative of a method 500 of reading barcodes, in accordance with an embodiment of the present invention. The method 500 can be implemented as a set of instructions stored on a computer-readable memory and executable on one or more processors.

In step 502, the method includes the operation of capturing (e.g., by an imaging assembly) an image of a target, the target including: (i) a first symbol encoding a first payload data, (ii) a second symbol encoding a second payload data, (iii) a first set of one or more alphanumeric characters containing a first payload descriptor associated with the first symbol, and (iv) a second set of one or more alphanumeric characters containing a second payload descriptor associated with the second symbol. In some instances, the first and/or second set of alphanumeric characters may further include a first and/or second alphanumeric string corresponding to the respective first and/or second payload data.

In step 504, the method includes the operation of decoding, by a second processor, the first symbol to extract the first payload data. In step 506, the method includes the operation of decoding, by the second processor, the second symbol to extract the second payload data. The first and second payload data extracted at steps 504 and 506 may be, e.g., data indicating a string of numbers and/or characters encoded by the first and second symbol, respectively.

In step 508, the method includes the operation of performing, by a first processor, an optical character recognition analysis on the first set of one or more alphanumeric characters to identify the first payload descriptor associated with the first symbol. In step 510, the method includes the operation of performing, by the first processor, an optical character recognition analysis on the second set of one or more alphanumeric characters to identify the second payload descriptor associated with the second symbol. In some instances, the optical character recognition analysis of steps 508 and/or 510 may also be performed on respective first and/or second alphanumeric string corresponding to the respective first and/or second payload data to identify respective first and/or second strings of numbers or characters. As discussed above with respect to FIG. 4, in some examples, the optical character recognition analysis may be performed on only a certain region of the image of the target where each set of alphanumeric characters is likely to be located. For example, at step 508, the optical character recognition analysis may be performed on a first region of the target image within a certain proximity of the first symbol, while at step 510, the optical character recognition analysis may be performed on a second region of the target image within a certain proximity of the second symbol. Of course, in other examples, the optical character recognition analysis may be performed over the entire image of the target.

In some instances, there may be errors in the optical character recognition analysis performed at steps 508 and/or 510. In such instances, the payload descriptor (with errors) from each optical character recognition analysis may be identified by matching the payload descriptor (with errors) to the closest payload descriptor from known set of possible payload descriptors (e.g., using fuzzy logic). For example, if the first payload descriptor (with errors) generated from the optical character recognition analysis is “SKH,” it may be matched to the known payload descriptor “SKU.” Similarly, if the second payload descriptor (with errors) generated from the optical character recognition analysis is “IMEF,” it may be matched to the known payload descriptor “IMEI.” Accordingly, the first payload descriptor may be identified as an “SKU” payload descriptor, while the second payload descriptor may be identified as an “IMEI” payload descriptor.

Similarly, each alphanumeric string (with errors) from the optical character recognition analysis performed at steps 508 and/or 510 may identified by matching the first and/or second alphanumeric string (with errors) to the first and/or second extracted payload data, (e.g., using fuzzy logic). As discussed above, while both decoding barcodes and OCR may incur errors, the error rate associated with OCR is typically much higher. Accordingly, when there are differences between the alphanumeric string corresponding to the payload data and the payload data extracted from the symbol, the payload data extracted from the symbol typically will be used to identify the alphanumeric string (rather than vice versa).

For example, if the first alphanumeric string (with errors) generated by the optical character recognition analysis is “1710258,” it may be matched to the extracted payload data from the first symbol, “1710254,” using a fuzzy logic comparison, or any other known method for comparison. Accordingly, the first alphanumeric string may be identified as a “1710254” alphanumeric string. Similarly, if the second alphanumeric string (with errors) generated by the optical character recognition analysis is “354691065333569,” it may be matched to the extracted payload data from the second symbol “354691065333567,” using a fuzzy logic comparison, or any other known method for comparison.

In step 512, the method includes the operation of associating the first payload data with the first payload descriptor, resulting in a first associated pair. In step 514, the method includes the operation of associating the second payload data with the second payload descriptor, resulting in a second associated pair.

In some examples, each of the first and second payload data may be associated with its respective first and second payload descriptor based on the position of each set of alphanumeric characters containing the payload descriptor with respect to each symbol encoding the payload data, e.g., in the captured image of the target. For example, the first set of alphanumeric characters may be positioned immediately above or immediately below the first symbol in some instances, while the second set of alphanumeric characters may be positioned immediately above or immediately below the second symbol. Additionally or alternatively, each of the first and second payload data may be associated with their respective first and second payload descriptors based on the proximity of the each set of alphanumeric characters to each symbol (e.g., based on whether the alphanumeric characters are within a certain threshold distance of the symbol). For example, the first set of alphanumeric characters may be closer in proximity to the first symbol, while the second set of alphanumeric characters may be closer in proximity to the second symbol. For example, in embodiments where each optical character recognition analysis is performed only within a first and/or second region of the image of the target (e.g., near the first symbol only, or near the second symbol only), the respective first and/or second set of alphanumeric characters may be located within respective first and/or second regions of the image.

In some instances, each of the first and second payload data may be associated with their respective first and second payload descriptors based on the identified first alphanumeric string corresponding to the first payload data, and on the identified second alphanumeric string corresponding to the second payload data. For example, when the alphanumeric characters include a payload descriptor as well as an alphanumeric string corresponding to the payload data, the first alphanumeric string corresponding to the first payload data may be matched to the extracted first payload data from the first symbol, while the second alphanumeric string corresponding to the second payload data may be matched to the extracted second payload data from the second symbol.

For example, the alphanumeric characters “R/S-SKU 1710254” and “IMEI 354691065333567” are both shown in FIG. 3. In this example, R/S-SKU and IMEI are payload descriptors, while 1710254 and 354691065333567 are respective alphanumeric strings. If a first symbol encodes first payload data “1710254”, matching the first alphanumeric string contained in the first alphanumeric characters “R/S-SKU 1710254”, then the first payload descriptor “R/S-SKU” contained in the first set of alphanumeric characters may be associated with the first payload data. Similarly, if a second symbol encodes second payload data “354691065333567”, matching the second alphanumeric string contained in the second set of alphanumeric characters “IMEI 354691065333567”, then the second payload descriptor “IMEI” contained in that second of alphanumeric characters may be associated with the second payload data.

In some instances, the extracted payload data most closely matching the alphanumeric string corresponding to the payload data may be associated with the payload descriptor. For example, a symbol encoding payload data for “1710258” (one number off the alphanumeric string associated with R/S-SKU, “1710254”) may be associated with the “R/S-SKU” payload descriptor due to the close, but not perfect, match. In contrast, a symbol encoding payload data for “1710258” would clearly not be a match with the alphanumeric string “354691065333567”, so that payload data would not be associated with the IMEI payload descriptor.

In step 516, the method includes the operation of forwarding the first associated pair to a third processor for further processing of the first payload data based on the first payload descriptor. In step 518, the method includes the operation of forwarding the second associated pair to a fourth processor for further processing of the second payload data based on the second payload descriptor.

In some instances, the further processing of the payload data may include inputting payload data into fields for specific payload descriptors, e.g., in an inventory application. For example, the first payload data may be input into a first field for a first payload descriptor, while the second payload data may be input into a second field for a second payload descriptor. Additionally or alternatively, the further processing of the payload data based on the payload descriptor may include changing the location of a physical object to which the target is affixed. For example, first payload data including a code for a destination, associated with a first payload descriptor indicating “destination” may indicate that a package to which the target is affixed should be put in a truck heading to that destination. As another example, second payload data indicating a code for a type of product, associated with a second payload descriptor indicating “product type” may indicate that a package to which the target is affixed should be placed in a certain area of a retail store. Accordingly, an incorrect association between payload data and payload descriptor could lead to a package to which the target is affixed being placed in an incorrect location.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of reading barcodes, the method comprising:
capturing, by an imaging assembly, an image of a target, the target including:
(i) a symbol encoding a payload data, and
(ii) a set of one or more alphanumeric characters containing a payload descriptor associated with the symbol;
decoding, by a first processor, the symbol to extract the payload data;
performing, by a second processor, an optical character recognition analysis on the set of one or more alphanumeric characters to identify the payload descriptor associated with the symbol;
associating the payload data with the payload descriptor, resulting in an associated pair; and
forwarding the associated pair to a third processor for further processing of the payload data based on the payload descriptor.

2. The method of claim 1, comprising: associating the payload data with the payload descriptor based on a position of the alphanumeric characters with respect to the symbol in the image of the target and/or associating the payload data with the payload descriptor based on a proximity of the alphanumeric characters with respect to symbol in the image of the target.

3. The method of claim 1, wherein the set of one or more alphanumeric characters containing the payload descriptor further contains an alphanumeric string corresponding to the payload data, and wherein associating the payload data with the payload descriptor further comprises:
performing an optical character recognition analysis on the set of one or more alphanumeric characters to identify the alphanumeric string corresponding to the payload data;
matching the payload data to the alphanumeric string corresponding to the payload data; and
associating the payload data with the payload descriptor contained in the same set of one or more alphanumeric characters as the matched alphanumeric string.

4. The method of claim 3, wherein matching the payload data to the alphanumeric string corresponding to the payload data comprises:
matching the payload data to the alphanumeric string corresponding to the payload data using a fuzzy logic comparison.

5. The method of claim 1, wherein performing the optical character recognition analysis on the set of one or more alphanumeric characters to identify the payload descriptor associated with the symbol comprises:
performing the optical character recognition analysis on a particular region of the image of the target based on the proximity of the region to the symbol.

6. The method of claim 5, wherein the particular region of the image of the target is immediately above, immediately below, or immediately adjacent to the symbol.

7. The method of claim 1, wherein performing the optical character recognition analysis on the set of one or more alphanumeric characters to identify the payload descriptor associated with the symbol comprises:
performing an optical character recognition analysis on the set of one or more alphanumeric characters to identify the payload descriptor;
comparing the identified payload descriptor to a plurality of known payload descriptors;
matching the identified payload descriptor to a particular known payload descriptor; and
associating the payload data with the particular known payload descriptor.

8. The method of claim 7, wherein comparing the identified payload descriptor to a particular known payload descriptor comprises comparing the identified payload descriptor to the plurality of known payload descriptors using a fuzzy logic comparison.

9. The method of claim 1, wherein one or more of the first processor, the second processor and/or the third processor are co-located logical processors.

10. A method of reading barcodes, the method comprising:
capturing, by an imaging assembly, an image of a target, the target including:
(i) a first symbol encoding a first payload data,
(ii) a second symbol encoding a second payload data,
(iii) a first set of one or more alphanumeric characters containing a first payload descriptor associated with the first symbol, and
(iv) a second set of one or more alphanumeric characters containing a second payload descriptor associated with the second symbol;
decoding, by a first processor, the first symbol to extract the first payload data;
decoding, by the first processor, the second symbol to extract the second payload data;
performing, by a second processor, an optical character recognition analysis on the first set of one or more alphanumeric characters to identify the first payload descriptor associated with the first symbol;
performing, by the second processor, an optical character recognition analysis on the second set of one or more alphanumeric characters to identify the second payload descriptor associated with the second symbol;
associating the first payload data with the first payload descriptor, resulting in a first associated pair;
associating the second payload data with the second payload descriptor, resulting in a second associated pair;
forwarding the first associated pair to a third processor for further processing of the first payload data based on the first payload descriptor; and
forwarding the second associated pair to a fourth processor for further processing of the second payload data based on the second payload descriptor.

11. The method of claim 10, comprising:
associating the first payload data with the first payload descriptor based on a position of the first set of alphanumeric characters with respect to the first symbol in the image of the target; and
associating the second payload data with the second payload descriptor based on a position of the second set of alphanumeric characters with respect to the second symbol in the image of the target.

12. The method of claim 11, wherein the first set of alphanumeric characters is in closer proximity to the first symbol than to the second symbol, and
wherein the second set of alphanumeric characters is in closer proximity to the second symbol than to the first symbol.

13. The method of claim 10, wherein the first set of one or more alphanumeric characters containing the first payload descriptor further contains a first alphanumeric string corresponding to the first payload data, and
wherein the second set of one or more alphanumeric characters containing the second payload descriptor further contains a second alphanumeric string corresponding to the second payload data, and
wherein associating the first payload data with the first payload descriptor further comprises:
performing an optical character recognition analysis on the first set of one or more alphanumeric characters to identify the first alphanumeric string corresponding to the first payload data;
matching the first payload data to the first alphanumeric string corresponding to the first payload data;
associating the first payload data with the first payload descriptor contained in the first set of one or more alphanumeric characters with the matched first alphanumeric string; and
wherein associating the second payload data with the second payload descriptor further comprises:
performing an optical character recognition analysis on the second set of one or more alphanumeric characters to identify the second alphanumeric string corresponding to the second payload data;
matching the second payload data to the second alphanumeric string corresponding to the second payload data; and
associating the second payload data with the second payload descriptor contained in the second set of one or more alphanumeric characters with the matched second alphanumeric string.

14. The method of claim 14, wherein matching the first payload data to the first alphanumeric string corresponding to the first payload data comprises:
matching the first payload data to the first alphanumeric string corresponding to the first payload data using a fuzzy logic comparison; and
wherein matching the second payload data to the second alphanumeric string corresponding to the second payload data comprises:
matching the second payload data to the second alphanumeric string corresponding to the second payload data using a fuzzy logic comparison.

15. The method of claim 10, wherein performing the optical character recognition analysis on the first set of one or more alphanumeric characters to identify the first payload descriptor associated with the first symbol comprises:
performing the optical character recognition analysis on a first region of the image of the target based on the proximity of the first region to the first symbol; and
wherein performing the optical character recognition analysis on the second set of one or more alphanumeric characters to identify the second payload descriptor associated with the second symbol comprises:
performing the optical character recognition analysis on a second region of the image of the target based on the proximity of the second region to the second symbol.

16. The method of claim 15, wherein the first region of the image of the target is immediately above, immediately below, or immediately adjacent to the first symbol, and wherein the second region of the image of the target is immediately above, immediately below, or immediately adjacent to the second symbol.

17. The method of claim 10, wherein one or more of the first processor, the second processor, the third processor, and/or the fourth processor are co-located logical processors.

18. The method of claim 10, wherein performing the optical character recognition analysis on the first set of one or more alphanumeric characters to identify the first payload descriptor associated with the first symbol comprises:
performing an optical character recognition analysis on the first set of one or more alphanumeric characters to identify the first payload descriptor;
comparing the identified first payload descriptor to a plurality of known payload descriptors;
matching the identified first payload descriptor to a first known payload descriptor; and
associating the first payload data with the first known payload descriptor;
wherein performing the optical character recognition analysis on the second set of one or more alphanumeric characters to identify the second payload descriptor associated with the second symbol comprises:
performing an optical character recognition analysis on the second set of one or more alphanumeric characters to identify the second payload descriptor;
comparing the identified second payload descriptor to the plurality of known payload descriptors;
matching the identified second payload descriptor to a second known payload descriptor; and
associating the second payload data with the second known payload descriptor.

19. The method of claim 18, wherein matching the identified first payload descriptor to a first known payload descriptor comprises matching the identified first payload descriptor to the first known payload descriptor using a fuzzy logic comparison; and wherein matching the identified second payload descriptor to a second known payload descriptor comprises matching the identified second payload descriptor to the second known payload descriptors using a fuzzy logic comparison.

20. A system for reading barcodes, comprising:
an imaging assembly configured to capture an image of a target, the target including:
(i) a symbol encoding a payload data, and
(ii) a set of one or more alphanumeric characters containing a payload descriptor associated with the symbol;
a memory configured to store computer executable instructions; and
at least one processor configured to interface with the image capture device and the memory, and configured to execute the computer executable instructions to cause the at least one processor to:
decode the symbol to extract the payload data;
perform an optical character recognition analysis on the set of one or more alphanumeric characters to identify the payload descriptor associated with the symbol;
associate the payload data with the payload descriptor, resulting in an associated pair; and
forward the associated pair for further processing of the payload data based on the payload descriptor.
